(19) United States
(12) Patent Application Publication
(10) Pub. No.: US 2025/0245349 A1
(43) Pub. Date: Jul. 31, 2025

(54) CUSTOM AI CO-PILOT FOR SOFTWARE SECURITY PEN-TESTING

(71) Applicant: UNIVERSITY OF SOUTH FLORIDA, Tampa, FL (US)

(72) Inventors: Xinming Ou, Tampa, FL (US); Dmitry B. Goldgof, Tampa, FL (US); Jarred Ligatti, Tampa, FL (US); Lawrence O'Higgins Hall, Tampa, FL (US)

(21) Appl. No.: 19/038,669

(22) Filed: Jan. 27, 2025

Related U.S. Application Data
(60) Provisional application No. 63/625,083, filed on Jan. 25, 2024.

(51) Int. Cl. G06F 21/57

(52) U.S. Cl. CPC G06F 21/577; G06F 2221/033

(57) ABSTRACT

Systems and method for detecting vulnerabilities in code are provided herein. A pre-trained artificial intelligence (AI) model is engaged, and a plurality of prompts and the source code are provided to the AI model. A plurality of detected vulnerabilities and a plurality of code locations in the source code are identified using the AI model. Each of the plurality of code locations corresponds to at least one of the plurality of detected vulnerabilities. One or more false positive vulnerabilities in the plurality of detected vulnerabilities are identified. A plurality of augmented prompts is generated, based on the one or more false positive vulnerabilities. The plurality of augmented prompts is outputted to a database of prompts for use in future code analyses, without necessarily having to retrain the AI model.

### CROSS-REFERENCE TO RELATED APPLICATIONS

This application claims the benefit of U.S. Provisional Application No. 63/625,083 filed on Jan. 25, 2024, the contents of which are incorporated herein in their entirety.

### STATEMENT REGARDING FEDERALLY SPONSORED RESEARCH OR DEVELOPMENT

This invention was made with government support under 2235102 awarded by National Science Foundation and N00014-23-1-2538 awarded by Navy Office of Naval Research. The government has certain rights in the invention.

### BACKGROUND

Large language models (LLMs) have made massive advancements in recent years. It has been hoped that LLMs could play a pivotal role in automating cyber security operations, denting the asymmetric advantages enjoyed by adversaries. LLMs have demonstrated human-like reasoning capabilities that are potentially useful for analyzing security events that have occurred, such as those addressed in a security operations center (SOC) of an organization.

However, software pen-testing presents a different set of hurdles than reviewing security events that have already occurred. Moreover, unlike some SOC operations (which are often documented per various protocols and standards), there is currently very little information available regarding how current proprietary code vulnerability analysis tools are designed, how LLM's are designed in terms of predictability of their outputs to changed prompting, and very little evidence regarding the effectiveness of using LLMs in the security domain, such as in pen-testing.

A goal of software pen-testing is to identify security vulnerabilities in program code. It is widely used as part of a company's secure software development life cycle, and is often considered one of the last steps. A development team and a pen-testing team within a company or business often work separately-remotely or in different locations, which may add a barrier to communication between them. Given the workload of a regular pen-tester, it may be difficult to go through the code files line by line and craft a software pen-testing plan curated just for a specific codebase. They often end up testing things that are limited to their information and expertise. Software pen-testers use a number of tools for checking program source code and identifying vulnerabilities, such as Fortify2 and SonarQube3. These tools often report a large number of findings that turn out to be false alarms. Large numbers of false alarms lead to pen-tester fatigue, and eventually ignoring those code analyzer's output altogether.

Using LLMs in pen-testing could, in theory, help address several challenges: the large amounts of false alarms, and the ability of “hunting” for attacks and/or vulnerabilities that are not readily reported by existing tools. These are challenging to the human brain, which while more capable at handling nuanced situations than a computer program, are bandwidth-limited and can easily succumb to burnout from repeated tasks with similar structures. Unlike a traditional computer program, an LLM can be trained on large amounts of data and produce responses to queries (prompts) that could exhibit the appearance of the type of nuanced reasoning capability of a human brain.

However, LLMs are generally pre-trained on very vast amounts of data, and are difficult to fine-tune or retrain for specific security tasks, especially given the rapidly changing nature and nuances of security pen-testing. As described below, the inventors determined that pre-trained LLMs exhibit a wide range of capabilities (from poor to average) when tasked with common pen-testing analyses, and even different LLMs can exhibit different results for the same prompts and same code. Furthermore, training LLMs for widespread use in security testing (e.g., by providing them a vast amount of code samples and labeled vulnerabilities) poses a number of practical problems: LLMs are computationally expensive to fully train (making updating them for new types of vulnerabilities a difficult task), vast labeled datasets do not exist, and training LLMs on code samples could inadvertently cause them to divulge private/confidential information and/or change their behavior relative to other code samples and vulnerabilities that they previously were able to detect reliably. Furthermore, an LLM-based pen-testing agent will not be useful to a pen-tester unless it is consistently reliable with consistent answers, and can identify vulnerabilities at least as accurately as existing code analysis tools.

Therefore, a need exists to address the challenges and problems facing use of LLMs for software penetration/vulnerability testing that will allow for consistent, reliable, and accurate results that generate net benefit to human pen-testers.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any of all aspects of the disclosure. Its purpose is to present some concepts of one or more aspects of the disclosure in a simplified form as a prelude to the more detailed description that is presented later.

In some aspects, the present disclosure can provide a method for detecting vulnerabilities in a source code. A trained artificial intelligence (AI) model can be obtained (such as an LLM or ensemble of LLMs, alone or in combination with a non-LLM based vulnerability analysis tool). A plurality of prompts and the source code can be provided to the AI model. A plurality of detected potential vulnerabilities and a plurality of associated code locations in the source code can be identified using the AI model. One or more false positive vulnerabilities in the plurality of detected vulnerabilities can be identified. A plurality of augmented prompts can be generated based on the one or more false positive vulnerabilities. The plurality of augmented prompts can be stored to a database of prompts associated with a profile.

In another aspect, the present disclosure can provide a non-transitory computer readable storage medium having instructions stored thereon that, in response to execution by a computing device, cause the computing device to obtain a trained artificial intelligence (AI) model. A plurality of prompts and a source code can be received. The plurality of prompts can include at least one security task prompt. The AI model can identify a plurality of vulnerabilities in the source code and a plurality of code locations. Each of the plurality of code locations can correspond to each of the plurality of vulnerabilities. One or more false positive vulnerabilities in the plurality of vulnerabilities can be identified. A plurality of augmented prompts can be automatically generated based on the one or more false positive vulnerabilities. The plurality of augmented prompts can be saved to a database of prompts.

In another aspect, the present disclosure can provide a system including a processor and a memory. The memory can have instructions that, when executed by the processor, cause the processor to obtain a trained large language model (LLM). A plurality of pen-testing prompts and a source code can be received. A plurality of vulnerabilities and a plurality of code locations in the source code can be detected using the LLM. The plurality of code locations can correspond to the plurality of vulnerabilities. One or more false positive vulnerabilities in the plurality of vulnerabilities can be detected. A plurality of augmented pen-testing prompts can be automatically generated based on the one or more false positive vulnerabilities. The plurality of augmented prompts can be saved to a database of prompts.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

The foregoing features of embodiments will be more readily understood by reference to the following detailed description, taken with reference to the accompanying drawings, in which:

FIG. 1 is a flowchart illustrating an example process for detecting vulnerabilities in source code, according to some embodiments.

FIG. 2 is a block diagram of an example software security system, according to some embodiments.

FIG. 3 is an example of a base prompt, according to some embodiments.

FIG. 4 is an example flow chart depicting a process for developing prompt augmentations for LLM-based vulnerability detection.

### DETAILED DESCRIPTION

The detailed description set forth below, in connection with the appended drawings, is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts. Various embodiments, implementations, advantages, configurations, and examples of the present disclosure are described below.

The disclosure in this detailed description section will include: discussion of methods, techniques, approaches, and associated general concepts that may be applicable to some or all of the more specific implementations contemplated herein, in the context of discussion of flowcharts; a discussion of various implementations, hardware, and data flow among possible users and operators of systems employing embodiments of the present disclosure, such as in the context of discussion of block diagrams; and a discussion of the inventors' experiments and examples/prototypes used for validation. Thus, the descriptions of specific embodiments/implementations/examples should be understood to be capable of incorporating the more general frameworks and concepts as well as features of other specific embodiments, and vice versa.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

### Example Processes

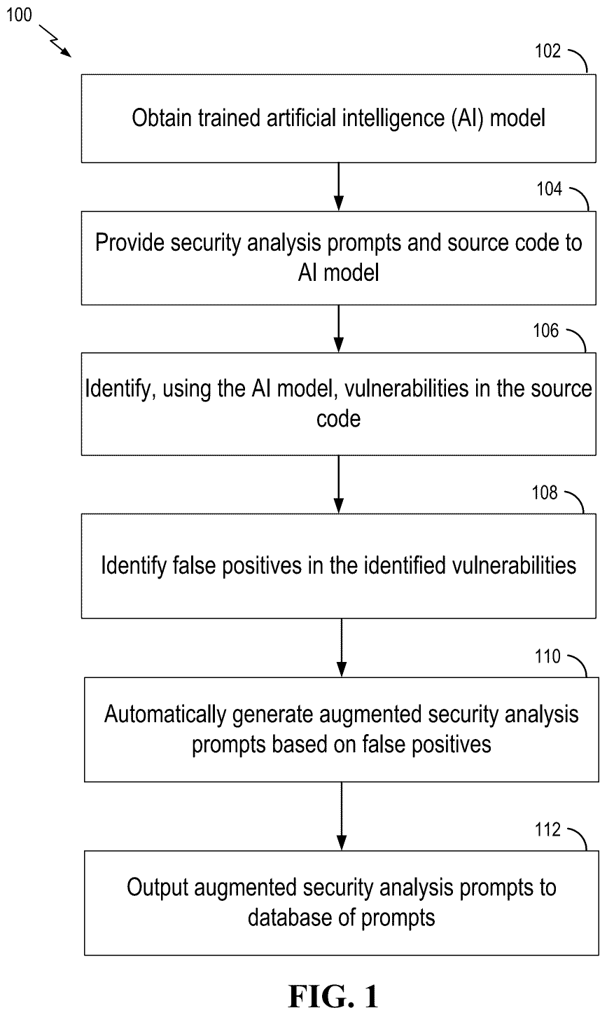

FIG. 1 is a flow diagram illustrating an example process 100 for detecting vulnerabilities in source code, according to some embodiments. As described below, a particular implementation can omit some or all illustrated features/steps, may be implemented in some embodiments in a different order, and may not require some illustrated features to implement all embodiments. In some examples, an apparatus can be used to perform all or part of example process 100. However, it should be appreciated that other suitable processing hardware for carrying out the operations or features described below may perform process 100.

At step 102, a trained artificial intelligence (AI) model is obtained. In some examples, the trained AI model can include a large language model (LLM), multiple LLMs, an ensemble of LLMs, or any type of model used for processing human language. In some instances, the trained AI model may be a generally-available multi-purpose pre-trained model (e.g., GPT, Gemini, etc.), or an LLM that was previously trained or fine-tuned for a specific purpose. In further examples, the AI model may also include a standard code vulnerability analysis tool, such as SonarQube.

At step 104, a source code to be tested (e.g., a source code file or files) and a type of security analysis are identified. For example, a user may specify types of code vulnerabilities to assess, or may request all vulnerabilities be analyzed by default. In some examples, the user input may include security analysis prompts, or process 100 may retrieve a suitable base prompt based upon attributes of the source code, the types of vulnerabilities to asses, and/or the nature of the AI model to be used. These inputs/prompts are provided to the AI along with a pointer or copy of the source code. In some examples, one or more prompts may define the task to be performed by the AI model (e.g., detect source code vulnerabilities). In some instances, the prompts may be augmented based on identified false positives from the AI model's initial (or a previous) response evaluation of the source code or similar code. The prompts may be augmented using text that is based on the specific type(s) of LLM model(s) used in the AI model, as well as a categorization associated with source code to be analyzed. In further examples, the prompts may contain specific areas within the source code to focus on, as well as step-by-step instructions on how the model should process/review the source code. In some examples, the source code may be associated with software development, system programming, data storage, analytics, or the like. In some examples, one or more prompts from a library or database of prompts may automatically be identified based on specific security (e.g., pen-testing) task associated with the source code provided to the AI model.

At step 106, vulnerabilities in the source code are identified by the AI model. In some examples, the portions of the code identified as potentially comprising potential code vulnerabilities may include code locations that exhibit vulnerabilities relating to command injection vulnerabilities, weak cryptography, weak hashing, lightweight directory access protocol (LDAP) injection, path traversal, secure cookie flag, structured query language (SQL) injection, trust boundary violation, weak randomness, .xml path language (XPATH) injection, cross-site scripting, or the like. A line position, rung, or the like associated with each vulnerability may further be identified.

At step 108, false positives in the identified vulnerabilities are detected. In some examples, process 100 may receive confirmations of false positives from a user, such as a pen-tester. The false positives may represent areas of code identified by the AI model as containing a vulnerability, but which have been identified (manually by a user or automatically by the system) as not actually presenting the identified vulnerability.

At step 110, augmented security analysis prompts are generated for one or more of the false positives identified at step 108. In some examples, the augmentation may be customized based on the type of false positive. For example, if step 106 falsely identified a line of code as containing weak hashing, the augmentation may instruct the AI model to double check or check for specific types of hashing vulnerabilities.

At step 112, the augmented security analysis prompts are outputted or saved to a database of prompts. In some examples, the database may be accessible for future use by a specific user, for a specific source code file, or all users of the example process 100. In some examples, the augmented prompts may be validated by providing them to the AI model to ensure the number of false positives is zero or has decreased.

### Example Systems and Data Flows

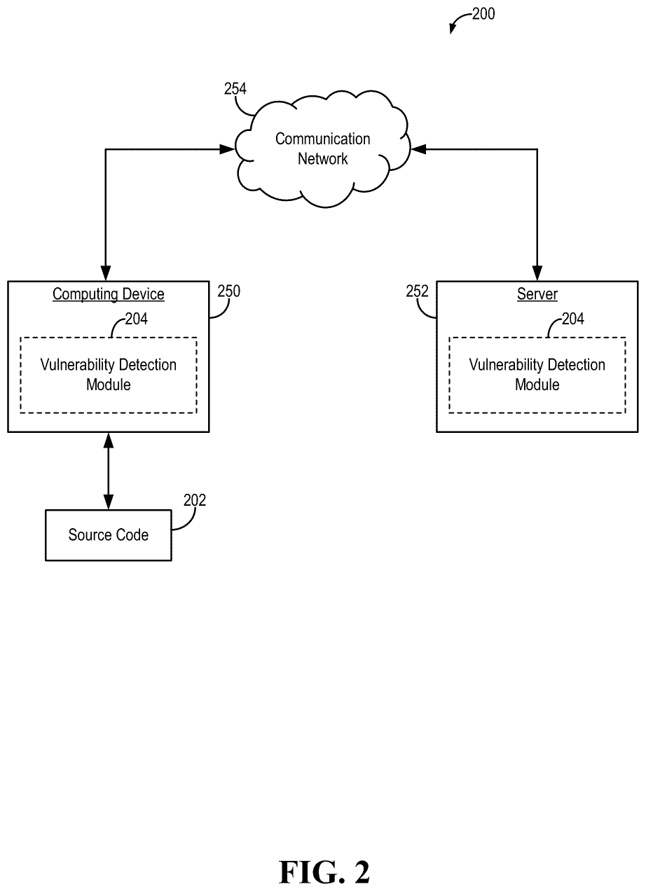

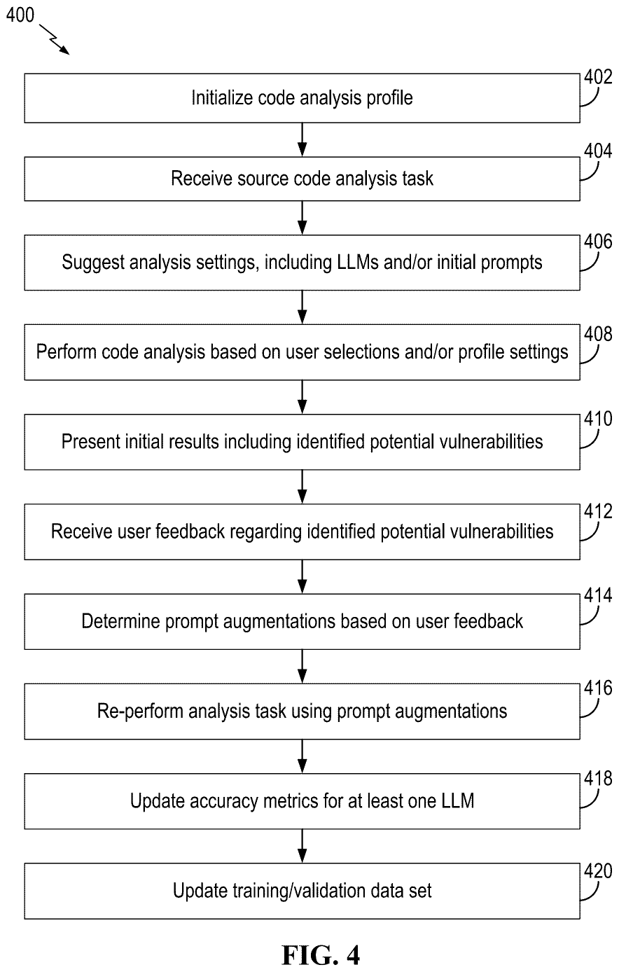

FIG. 2 shows an example of a security system 200 for performing vulnerability detection, such as some or all of the processes, algorithms, approaches, and steps described in FIG. 1, FIG. 4, the Examples section, or elsewhere throughout this disclosure. In general, such processes should be understood as describing the actions of user-focused systems (e.g., user interfaces, local/organizational systems that manage profiles and local/private LLMs and training/validation sets) as well as the actions of software providers and service providers that may manage the systems and platforms that enable such processes.

As shown in FIG. 2, a computing device 250 can receive one or more types of source code (e.g., code used for software development, web development, game development, system programming, automation, embedded systems, analytics, security, or the like) from data source 202. For example, computing device 250 may comprise a server, cloud resource, workstation, or other resource having an integrated circuit (IC), a computing chip, or any suitable computing device that is able to compute large amounts of computations in parallel, as would be involved in deploying an artificial intelligence model. In some examples, the computing device 250 can be a special purpose device to implement an artificial intelligence agent, such as a vulnerability detection module 204.

Additionally, or alternatively, in some embodiments, the computing device 250 can communicate information about data received from the data source 202 to a server 252 over a communication network 254, which can execute at least a portion of the vulnerability detection module 204. For example, server 252 may comprise a mobile device connected to computing device 250, a mobile application, or a remote server. In such embodiments, the server 252 can return information to the computing device 250 (and/or any other suitable computing device, such as a mobile device) indicative of detected vulnerabilities identified in the source code from the data source 202.

In some embodiments, computing device 250 and/or server 252 can be any suitable computing device or combination of devices, such as laptop computer, a smartphone, a desktop computer, a tablet computer, a server computer, a virtual machine being executed by a physical computing device, a cloud resource, a set of GPUs, or the like.

In some embodiments, data source 202 can be any suitable source of data, such as a device configured to receive code manually entered by a user, a repository, data file, a server, a software program, a library, or the like. In some embodiments, data source 202 can be local to computing device 250. For example, data source 202 can be incorporated with computing device 250 (e.g., computing device 250 can be configured as part of a device for receiving manual code entries or storing code repositories). As another example, data source 202 can be connected to computing device 250 by a cable, a direct wireless link, and so on. Additionally, or alternatively, in some embodiments, data source 202 can be located locally and/or remotely from computing device 250, and can communicate data to computing device 250 (and/or server 252) via a communication network (e.g., communication network 254).

In some embodiments, communication network 254 can be any suitable communication network or combination of communication networks. For example, communication network 254 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 254 can be a local area network, a wide area network, a public network (e.g., the Internet), a private or semi-private network (e.g., a corporate or university intranet), any other suitable type of network, or any suitable combination of networks. Communications links shown in FIG. 2 can each be any suitable communications link or combination of communications links, such as wired links, fiber optic links, Wi-Fi links, Bluetooth links, cellular links, and so on.

Referring now to FIG. 4, an example process 400 is depicted, for refining accuracy of an LLM-based penetration testing solution. The process 400 can achieve refined accuracy not by directly training or retraining the model (e.g., by adjusting the weights and content of the model through providing training examples), but by iteratively augmenting prompts that improve the performance of the pre-trained LLM at identifying specific types of vulnerabilities.

In some embodiments, the process 400 begins with the initiation of a code analysis software profile tailored to a specific user or organization. This profile may incorporate one or more existing code analysis tools (such as existing penetration testing software, as described below), interfaces to one or more large language models (LLMs) or an ensemble of LLMs, and may include a combination of these elements. The content of the code analysis profile may be determined based on predefined criteria (e.g., options selected by a code developer/user or predefined by a software company that deploys software or services that utilize and manage the profile), or through dynamic assessment of the available tools and models and their relative accuracies. For example, the process 400 may involve a local software tool or web-based solution, in which a user logs into their profile and accesses software that interfaces with open-source code analysis tools, proprietary code-analysis tools, open-source LLMs, proprietary LLM APIs, or local LLM instances. In some embodiments, where the process 400 interfaces with pre-trained and non-local LLMs, the process 400 may manage content of what is sent to or saved by the LLMs, to ensure privacy and compliance with user-specific data protection requirements.

The software profile may further include access to a repository of base prompts, augmented prompt templates, tailored prompts developed by the user, and/or a library of augmented prompts. Examples of the content of such prompts is set forth below in the Examples and Experiments section. As demonstrated by the results of the inventors' findings, while some prompts may be specific to particular code snippets or function calls of a given application, the usage of these prompts can improve accuracy of LLMs beyond simply the specified example; instead, these prompts can improve the accuracy of a pre-trained, non-fine-tuned LLM in identifying other and similar code vulnerabilities—even previously unseen vulnerabilities.

In some embodiments, these prompts may be associated with metrics indicating their effectiveness on accuracy improvement when used with specific LLMs or types of LLMs. The metric metadata may track performance metrics such as false positive rates, true positive rates, and vulnerability type coverage. In some embodiments, the system organizes prompts into predefined vulnerability categories, such as categories that align with industry standards, categories used by a companion open source or proprietary code vulnerability program, or per user-defined structures. Examples of such categories include command injection vulnerabilities, weak hashing algorithms, and SQL injection flaws. Other embodiments may further combine categories into general groupings, based on the general type of vulnerability (e.g., weakness of a given attribute, etc.) as further described below. The metric data may thus provide an indication of the current reliability of each model for detecting vulnerabilities within each category and/or grouping, including when using base prompts, various combinations of augmented prompts, and their best-performing augmentations.

Additionally, the system may support customization of the LLM integration for privacy purposes. For instance, in certain embodiments, the LLMs may be configured to operate entirely within the user's local environment, thereby ensuring that sensitive source code data is not transmitted to external servers. In other embodiments, a private instance of the LLMs may be operated by a service provider that monitors prompt augmentations from its users on a private and confidential basis; thus, when a given type of prompt is consistently being given to one or more of the LLMs, the service provider can train the LLMs based upon training sets that include one or more specific examples of vulnerabilities that are being missed or cause false positives, as form of reinforcement learning for the LLMs. This approach allows the service provider to utilize anonymized or non-private training information that mimic or mirrors private scenarios encountered by users to train an LLM to address a given type of vulnerability, while avoiding the possibility of an LLM “learning” a private code example and/or being able to recreate private code for the wrong users, and avoiding users having to consistently use prompt augmentations over and over.

At block 404, process 400 may receive software code (e.g., in the form of source code, files, semi-compiled code, etc.) to validate and for which a user is working on a penetration testing task. The source code may be provided directly, for example, as a set of uploaded files, or indirectly, as a pointer to a repository, directory, or other location containing the code. In some embodiments, the source code may be accompanied by attribute data, such as metadata describing the code's modules, dependencies, libraries, or function calls. Process 400 may also extract such attribute data dynamically through an initial analysis of the provided source code. This attribute data may be utilized by a software solution or service provider to guide or enhance other steps of process 400 by enabling the selection or suggestion of prompts and models that are tailored to, or more likely to provide accurate vulnerability detection given, the structural and functional characteristics of the analyzed codebase or uploaded code.

At block 406, process 400 may optionally suggest one or more LLMs or an ensemble of LLMs to utilize; base prompts; and/or augmented prompts for each LLM based on the attribute data associated with the source code received at block 404. In some embodiments, process 400 may also (or alternatively) suggest or display predefined prompt templates tailored to specific categories or groupings of vulnerabilities, such as templates corresponding to industry-standard or tailored vulnerability categorizations (e.g., OWASP Top 10), such as for command injection vulnerabilities. For example, in some embodiments, process 400 may output and manage a user interface for the software pen-tester/user, in which the process 400 can guide the user through developing specific augmented prompts by following a formula or template that has been verified to improve performance for the selected LLMs (globally, or on an LLM-by-LLM basis) based upon a service provider's accumulated data of users' prompt effectiveness.

For example, the user interface may present templates tailored to specific types of vulnerabilities, such as weakness-based vulnerabilities, and suggest constructs like: “Before [action], consider [criteria or condition].” The penetration tester could then populate the placeholders with specific details related to the identified false positive, such as “reporting a weak hashing algorithm” and “whether the hashing algorithm is SHAI or MD5.” As other examples, the user interface of process 400 may also provide prompt formats or templates following other styles, such as conditional prompts, exclusion prompts, inclusion prompts, and clarification prompts. For example, additional formats that the user interface might suggest include:
Conditional prompts: “If [condition] is met, then [action].” For example, “If the cryptographic library used does not support AES/GCM, then flag this as weak cryptography.”
Exclusion prompts: “Exclude [specific case] when [condition].” For instance, “Exclude path traversal vulnerabilities when the input parameter is sanitized using a known safe method.”
Clarification prompts: “Verify [specific detail] before [action].” For example, “Verify the value of the variable ‘keyLength’ before reporting it as weak cryptography.”

Alternatively, process 400 may dynamically generate augmented prompts upon a user confirming that an identified potential vulnerability was in fact accurate or was in fact a false positive. In some embodiments, these dynamically generated augmented prompts may be based on extracted code attributes that were the basis of the identified potential vulnerability, such as the use of particular libraries or frameworks. For example, if the attribute data indicates the presence of a database access library, process 400 may develop and suggest augmented prompts designed to identify vulnerabilities associated with SQL injection.

Process 400 may also consider the historical performance of different LLMs for various vulnerability categories when suggesting prompts. In some embodiments, process 400 may present these suggestions to the user alongside metadata, such as the accuracy of specific LLMs for each vulnerability type or the success rate of previously applied prompt augmentation formats or templates. This optional step enables process 400 to refine the analysis configuration by aligning it with the strengths and limitations of available LLMs and prompts.

At block 408, process 400 may run a code vulnerability analysis using one or more LLMs (and/or in parallel with a non-LLM based code vulnerability analyzer tool), to identify potential vulnerabilities in the uploaded or designated source code. The analysis may be initiated by process 400 using base prompts only, or by process 400 utilizing one or more augmented prompts (e.g., where the user or service provider has designated certain prompt augmentations as being suitable for global use, such as being stable and consistent in terms of improved accuracy over a given threshold percentage during validation testing). In some embodiments, process 400 may prioritize or filter the LLMs that are utilized for this analysis based on predetermined criteria, such whether metric data establishes that LLMs meet a threshold accuracy for a given type of vulnerability. For instance, process 400 may only use LLMs that have demonstrated an accuracy of 70% or higher for detecting command injection vulnerabilities, or LLMS that have exhibited an accuracy of at least more than 50% for at least one, two, three, or more categories of vulnerabilities, or LLMs that have exhibited an accuracy of at least 70%, 75%, 80%, 85%, 89%, 90%, 95%, 97%, etc. for at least one, two, three, or more categories of vulnerabilities, or LLMs that are in the top three most accurate for at least one category of vulnerability, or other similar criteria (whether user selected criteria, or imposed by the service provider, or dictated by industry standards). Alternatively, process 400 may always use a subset of models, such as the top three performing LLMs for a particular vulnerability category, to improve confidence in the analysis results.

At block 410, process 400 may present the initial analysis results to a user, such as providing a listing or report of the identified potential vulnerabilities (e.g., by giving a user the ability to drill down by type of vulnerability, etc.). The process 400 may also provide a user with an indication of which LLMs and/or non-LLM code analysis tools identified specific vulnerabilities and providing associated accuracy metrics for the models/tools and an indication of how their accuracies compare to other LLMs/tools.

Depending on configuration, process 400 may also implement code or logic to determine whether to display all identified vulnerabilities or only those that meet specific user-defined or service-provider-defined criteria. For example, process 400 may restrict the output to vulnerabilities identified by at least one, two, three, or more LLMs, to those that meet predefined confidence thresholds (e.g., where an LLM is prompted to generate a confidence score with its results), or to those that came from a model or tool that has exhibited at least a threshold level of accuracy for the given vulnerability type(s) that it identified. Thus, it can be recognized that LLMs and tools that are utilized to run a code analysis can be configured to look for all types, categories and/or groupings of vulnerabilities every time they are used, or prompted to only look for types, categories, and/or groupings of vulnerabilities for which the LLM or tool has exhibited or is currently known to exhibit a threshold of accuracy.

In some embodiments, process 400 may present each identified vulnerability to a user via a user interface in a manner such that the user can readily assess whether an identified potential vulnerability is correctly identified or a false positive. (As described below, the inventors have determined that merely augmenting prompts to an LLM in regard to false positives, but not attempting to augment based on overlooked vulnerabilities, can improve the overall performance accuracy of the LLM at detecting vulnerabilities of a given type in general—i.e., improving the LLM's performance in catching vulnerabilities as well as reducing false positives.). Thus, in some embodiments, a user interface may identify a vulnerability, identify the type of vulnerability it is, and accompany those indications with an indication of a code location of the potential vulnerability, a depiction of the relevant code segment and/or the context in which the segment is utilized by the code. In some embodiments, process 400 may leverage explainable AI techniques to provide contextual information about the vulnerability and its potential impact, and why the LLM identified it as a potential vulnerability. For example, process 400 may highlight the specific lines of code responsible for the vulnerability, along with an explanation of why the identified behavior could constitute a security risk, display generated natural language descriptions of detected vulnerabilities, or overlay visual annotations on the code segments to indicate why the structure of the segment could constitute a security risk.

In some embodiments, process 400 may further suggest code modifications, additions, or alternatives to address the identified vulnerabilities. These suggestions may include specific changes to function calls, logic, or data handling practices, and may be presented in addition to or instead of the explanations described above. In some embodiments, process 400 may also rank or prioritize the suggested changes based on their expected impact on security, usability, or other metrics relevant to the user's objectives. By providing this information, a user may be given additional insight into why the LLM believed a vulnerability exists, as well as potential resolutions.

At block 412, process 400 may receive an indication from a user regarding whether an identified vulnerability has been accurately detected or constitutes a false positive. In some embodiments, process 400 may facilitate this input by presenting the user with an interactive interface that highlights each identified vulnerability and provides options for confirmation or rejection. For example, process 400 may allow users to label a finding as “Confirmed Vulnerability” or “False Positive” through a selection mechanism displayed in the user interface.

In some embodiments, process 400 may retain this feedback so as to allow a service provider or future user to evaluate whether one or more LLMs or ensembles should be trained based on a similar type of vulnerability, and/or to refine subsequent steps. For instance, if a user confirms a vulnerability as accurately identified, process 400 may automatically generate a prompt augmentation for the LLMs that failed to detect the vulnerability. This generated prompt may include details such as the vulnerability type, code segment, and reasoning for why the code constitutes a vulnerability. In further embodiments, these prompt augmentations may then be evaluated for future inclusion in base prompts for those LLMs, such as by using the augmented prompts to analyze a training set of code examples and determine if the augmented prompts consistently improve performance. Alternatively, process 400 may automatically generate variations of augmented prompts designed to guide LLMs in recognizing similar vulnerabilities in future analyses.

At block 414, process 400 may allow the user to generate augmented prompts when an identified vulnerability is labeled as a false positive. In some embodiments, process 400 may suggest templates or provide guidance for creating effective prompts based on prior performance data, such as described above. For example, if a false positive is associated with a weak hashing vulnerability, process 400 may recommend a prompt structure, and request the user to complete a template prompt for the given false positive, such as “Before reporting [vulnerability type], carefully evaluate [specific criteria].” These templates may be tailored to the specific LLMs involved, leveraging historical data on which prompt styles have improved accuracy for each model for each category of vulnerability.

After a user has completed a first prompt augmentation for a given false positive, some embodiments leveraging process 400 may also utilize an LLM to assist in generating variations of that prompt, cither automatically or in conjunction with user input. For instance, process 400 may request a user to complete one prompt template, and then based on the user input may present a set of alternatively-worded prompts addressing the same false positive using the same information, which can then (upon user approval) be validated and selectively utilized in future prompts to one or more LLMs.

At block 416, process 400 may optionally re-run the analysis of the given code using one or more augmented prompts. In other words, where a user or service provider has selected such functionality, process 400 may add the prompt augmentations (whether solely the user-defined augmented prompts, solely prompts to low-performing LLMs, etc.) to the base prompts (or, in an iterative fashion, to the last augmented prompt used) and instruct the same LLMs according to the augmented prompt (in some embodiments, non-LLM based code analysis tools need not be re-run, as their outputs may be static for a given code example; however the results displayed may still show a user that the non-LLM based code analysis tool was run on the code and what is results were).

In some embodiments, process 400 may evaluate, or present a user the ability to evaluate, the results of the reanalysis to determine whether the false positive(s) remain identified (or have now disappeared from the results) and/or whether new vulnerabilities are now identified. If the augmented prompts fail to resolve the false positive, process 400 may iteratively refine the prompts with user input based on the characteristics of the false positive or feedback provided by the user. Conversely, if new vulnerabilities are identified during the reanalysis, process 400 may return to earlier steps and solicit user input, such as presenting the new findings at block 410 and collecting user feedback at block 412.

At block 418, once any iterative refinement of augmented prompts has completed, process 400 may then provide a user an option to utilize the augmented prompts for future analysis (whether to replace base prompts, in combination with other prompt augmentations, only in certain circumstances or certain types of code or types of analysis tasks, etc.). Process 400 may further request the user to input an indication of whether the user consents to a service provider operating process 400 to consider using the prompt augmentations and associated code segments for purposes of future training/re-training of the underlying LLM or ensemble of LLMs (whether for the user's organization/subscription only, or for any and all users and subscribers). Process 400 may also optionally utilize all LLMs available to process 400 to run analyses with the augmented prompts (and/or variations thereof) on a predefined training set to update potential accuracy metrics for the user's profile and/or all profiles associated with the user's organization. These metrics may be associated with each LLM and recorded within the user profile initiated at block 402. In some embodiments, process 400 may calculate model accuracy as a weighted average of results from the local training data and generalized training data, providing a comprehensive assessment of each model's performance.

At block 420, depending upon user consent and settings, process 400 may optionally update the local training set (or global training set) to include some or all vulnerabilities that a user confirmed as accurate or false positives, alone or in conjunction with verified prompt augmentations. This updated training set may serve as a reference for future analyses, enhancing the ability of process 400 to refine and improve prompt augmentation strategies. Therefore, process 400 may also involve integrating results of prior analyses, whether for purposes of future prompt format/template suggestions, for updating prompt libraries, for update base prompts, and/or for training private LLM instances directly.

### Examples and Experiments

Described below are experimental setups and validations of the disclosed systems and methodologies. In some examples, the approaches described herein may be used to detect vulnerabilities and other security risks in source code files.

The inventors determined that, through providing more fulsome and detailed prompts that offer the knowledge, examples, and context beyond a base prompt, the same pre-trained LLM model can produce responses that match better with users' expectations. This discovery and the techniques described herein may be leveraged to create and deploy a dynamic AI security agent that can adapt to the specific usage environment and become more efficient as it interacts with the human user. And, this can be done without segregating a private LLM or using private information to train a public LLM.

In the inventors' work, a number of AI agents were built using AI models. Specifically, the LLMs GPT-3.5-Turbo, GPT-4-Turbo, and Gemini-pro were used. For the GPT models, two agents were built for each model, one using the Chat Completions API4 and the other using the Assistants API5. Prompts were designed for these LLMs and the program source code was fed to them. Questions were then asked about what vulnerabilities are found in the source code and the location (line number) of the vulnerability. The test cases were evaluated to determine the accuracy of these AI agents. The benchmark contained 2740 Java programs with a variety of vulnerabilities such as SQL injection, cross-site scripting, weak hashing algorithm, and so on. The results were compared with that from SonarQube, a tool widely used in software industry for checking software source code for vulnerabilities. SonarQube also performs better on the OWASP benchmark than the majority of other static software pen-testing tools; however, other non-LLM based tools similar to SonarQube can also be utilized in the processes and systems described herein. To examine the capability for the AI agent to be improved through prompt engineering, the benchmark's test cases were divided into training and testing sets. The prompts used in the agents are augmented based on observing the agents' responses on the training set. A goal of augmenting the prompts was to add guidance specific to the category of the task the LLM is currently trying to accomplish, so that higher accuracy can be achieved. The new prompts are then tested on the testing set, which has never been seen during the prompt engineering process. The performance of the AI agents were compared using the original base prompts, and the agents using the augmented prompts. The following was observed: (1) without prompt engineering, the LLMs' accuracy is either below or on par with that of SonarQube; and (2) with prompt engineering, GPT-4-Turbo using the Assistants API demonstrated substantial improvements on the accuracy, outperforming or being on par with SonarQube in most of the vulnerability categories.

These results validate the systems and methods described above, including the approach for using LLM(s) to build an ‘AI agent’ to support software penetration testing and vulnerability analyses, that can be constantly improved through prompt engineering driven by usage. The cases were further compared to where an LLM model performs differently. The analysis shows that a key reason why LLMs cannot perform better is the insufficient understanding of program code flow.

### OWASP Benchmark

TABLE 1
OWASP Benchmark v1.2 Test Cases

| Vulnerability Area | True Positive | False Positive | Total |
|---|---|---|---|
| Command Injection | 126 | 125 | 251 |
| Weak Cryptography | 130 | 116 | 246 |
| Weak Hashing | 129 | 107 | 236 |
| LDAP Injection | 27 | 32 | 59 |
| Path Traversal | 133 | 135 | 268 |
| Secure Cookie Flag | 36 | 31 | 67 |
| SQL Injection | 272 | 232 | 504 |
| Trust Boundary Violation | 83 | 43 | 126 |
| Weak Randomness | 218 | 275 | 493 |
| XPATH Injection | 15 | 20 | 35 |
| Cross-Site Scripting | 246 | 209 | 455 |
| Total | 1415 | 1325 | 2740 |

The OWASP Benchmark is a Java test suite for evaluating automated software vulnerability detection tools, including both SAST and DAST. The test cases were used in v1.2, which is a fully executable web application. The benchmark consists of 2740 test cases, each of which is a separate webpage inside the web app. All the vulnerabilities present in the benchmark are fully exploitable. The benchmark organizes the test cases based on the type of vulnerability present in the code. Each test case has either zero or one vulnerability present. Ground truth is given for each test case-true positive (vulnerability present) or false positive (vulnerability not present). Table 1 shows the distribution of test cases across vulnerability types and ground truth.

### Large Language Models Used

TABLE 2
LLMs Used in the Research

| Shorthand Name | Model Name | API Used |
|---|---|---|
| GPT-3.5-Turbo | gpt-3.5-turbo | ChatCompletion |
| GPT-4-Turbo | gpt-4-1106-preview | ChatCompletion |
| Gemini-Pro | gemini-pro | google-generativeai |
| GPT-3.5-Turbo Assistant | gpt-3.5-turbo | AssistantsAPI |
| GPT-4-Turbo Assistant | gpt-4-1106-preview | AssistantsAPI |

Three LLMs were used: Google's Gemini Pro, OpenAI's GPT-3.5-Turbo, and GPT-4-Turbo. For each GPT model, OpenAI provides two versions of APIs to interact with the models: the Chat Completions API and the Assistants API. Described herein, the shorthand name is used to refer to a combination of LLM model and API used in the AI agent (Table 2).

### Prompt Engineering

The test cases in the OWASP Benchmark were divided into a training set and a testing set. The division was done randomly within each vulnerability category, to have 20% of the test cases in each category in the training, and the rest in testing. Only the code in the training set was seen in the prompt engineering process.

Base prompts were developed so as to provide just enough guidance and context to the LLM to accurately portray the knowledge and direction an entry level software penetration tester would have when analyzing code. This can be seen in the format of the prompt where it provides a role:
“You are a security code analysis tool. Your job is to find security vulnerabilities in the code . . . ”,
   It also provides additional text that mandates the model behave in the manner of how one would perform due diligence when working in the field such as “Double check your report.” and “Only report something . . . if you are 100 percent confident . . . ” Working directives were also provided in the base prompt, which explain what to look for and when to report:
“Look at the following code and tell me what vulnerabilities are present in it if any.”
   In the end of the prompt, the possible types of vulnerabilities that could be present and how to report them were also provided.

Based on these experiments, the inventors discovered that the cases where LLMs tend to make mistakes are false positives. Notably, the inventors established (based on their experiments), that LLM performance can be improved solely by providing augmented prompts that correct for these false positives—AI agents and related tools as described herein can achieve general improvement in accuracy (both in detecting vulnerabilities/reducing false negatives, and reducing false positives) even when only prompts addressing false positives are used to augment base prompts. Moreover, the improvement in performance is not limited only to the specific false positive for which an augmented prompt is developed; instead, an augmented prompt actually improves the ability of an AI agent to correctly detect other vulnerabilities that it has not seen before. The common false positives that the inventors identified as being amenable to prompt augmentation (and, thus improvement in accuracy) can be broadly classified into two types:
(1) Code Flow: In this type, the program being vulnerable or not depends upon code flow and the LLM cannot reason about the code flow correctly. Table 3 shows two simplified examples of false positives from the benchmark. Both were marked incorrectly by GPT-4-Turbo, and correctly by GPT-4-Turbo Assistant. Under Benchmark #02669, we can see that the value of bar is always going to be the string “safe3”, thus the user-provided parameter param never gets injected in the bar variable and the code is not vulnerable. In Benchmark #007238, it can be observed that the value of bar is going to be the string “safe”, and the user parameter will not be injected.
(2) Use of weak algorithms: In this type, the program being vulnerable or not depends upon whether it uses a weak algorithm, and the LLM fails to determine that the algorithm is actually not weak. Table 4 shows two simplified examples from the benchmark, which again are false positive. Under Benchmark #00443, “AES/GCM/NOPADDING” is not a weak algorithm. In Benchmark #00640, the “getProperty” function tries to read the property “hashAlg2” from a file and if the operation fails it falls back to “SHA-5”. The value of “hashAlg2” as stored in the file is SHA-256, not a weak hashing algorithm. Since the LLM is not given the file's content it is unable to determine what hashing algorithm is used. The value of hashAlg2 is supplied in the augmented prompt as shown in Table 5.

TABLE 3
Code Flow

| | Command Line Injection: |
|---|---|
| Pathtraver: Benchmark #02669 | Benchmark #00738 |
| String bar = “safe1”; | String bar; |
| List<String> valuesList = | int num = 86; |
| new ArrayList<>( ); | |
| valuesList.add(“safe2”); | bar = ((7*42) − num > 200) ? “safe”: |
| valuesList.add(param); | param; |
| valuesList.add(“safe3”); | |
| valuesList.remove(0); | |
| bar = valuesList.get(1); | |

TABLE 4
Weak Algorithms

| Weak Cryptography: | |
|---|---|
| Benchmark #00443 | Weak Hashing: Benchmark #00640 |
| Javax.crypto.Cipher c = | String algorithm = benchmarkprops. |
| javax.crypto.Cipher. | getProperty(“hasAlg2”, “SHA5”); |
| getInstance(“AES/GCM/ | |
| NOPADDING”) | |

Each error made by the LLMs falls into one of the two categories as discussed above. Thus, prompt augmentations are written in to correct these errors in a format that is based on the category they belong to. Weak Cryptography, Weak Hashing, and Weak Randomness fall in the “Use of Weak Algorithms” category. Command Injection, LDAP Injection, Path Traversal, Secure Cookie Flag, SQL Injection, Trust Boundary Violation, XPATH Injection, Cross-site scripting fall in the “Code Flow” category. Thus, as shown below, a format for the corrective/augmented prompt for categories in these groupings can follow similar structures. By utilizing similar prompt structures, a system as described herein can avoid instability or unexpected results, and better zero-in on substantive improvements, by only modifying certain “blanks” within a consistent prompt format (and, thus, only modifying certain ‘variables’ as each iterative prompt is attempted). The added prompts for one of the inventors' experiments are listed in Table V.

TABLE 5
Added Prompts

| Vulnerability | Prompt |
|---|---|
| Command Injection | Before reporting cmdi, carefully look at the value that is being supplied |
| | to arglist variable. If the arglist value contains a constant string not |
| | containing the param then there is no cmdi vulnerability. |
| Weak | Only DES/CBC/PKCS5Padding is considered a weak crypto algorithm. |
| Cryptography | cryptoAlg1 is DES/ECB/PKCS5Padding and hashAlg2 is |
| | AES/CCM/NoPadding. Consider that benchmark file is always read |
| | successfully. |
| Weak Hashing | Only SHA1 and MD5 are considered weak hashing algorithms. |
| | hashAlg1 is MD5 and hashAlg2 is SHA-256. Consider that benchmark |
| | file is always read successfully. |
| LDAP Injection | Before reporting ldapi, carefully look at the filter for the ldap client. If |
| | the user provided parameter can't be injected into the filter then there is |
| | no ldapi security vulnerability. |
| Path Traversal | Before reporting pathtraver, carefully look at the bar value that is being |
| | injected in the filename variable. If user provided parameter isn't being |
| | injected in the filename parameter then there then there is no |
| | vulnerability. |
| Secure Cookie Flag | Before reporting securecookie, carefully look at the bar value that is |
| | being supplied to the cookie. If user provided parameter isn't being |
| | injected in the cookie then there then there is no securecookie |
| | vulnerability. |
| SQL Injection | Before reporting sqli, carefully look at the bar value that is being |
| | injected in the sql query. If user provided parameter isn't being injected |
| | in the sql query then there then there is no vulnerability. For this |
| | codebase, SQL queries without the use of PreparedStatement can be |
| | safe from SQL Injection. |
| Trust Boundary | Before reporting trustbound, carefully look at the value that is being |
| Violation | supplied to request.getSession( ).putValue(var, “ANY NUMBER”); If |
| | the var value contains a constant string not containing the param then |
| | there is no vulnerability. |
| Weak Randomness | The use of java.util.Random means a weak cryptography vulnerability is |
| | present. For this code base the use of |
| | java.security.SecureRandom(“SHA1PRNG”) implies a strong |
| | cryptography is used. |
| XPATH Injection | Before reporting xpathi, carefully look at the value that is being |
| | supplied to the expression which is fed to nodelist. If the expression |
| | value contains a constant string not containing the param then there is |
| | no xpathi vulnerability. |
| Cross-Site | Before reporting xss, carefully look at the bar variable that is specified |
| Scripting | to response.getWriter function. If the bar variable contains a constant |
| | string not containing the param then there is no xss vulnerability. |

### Evaluation

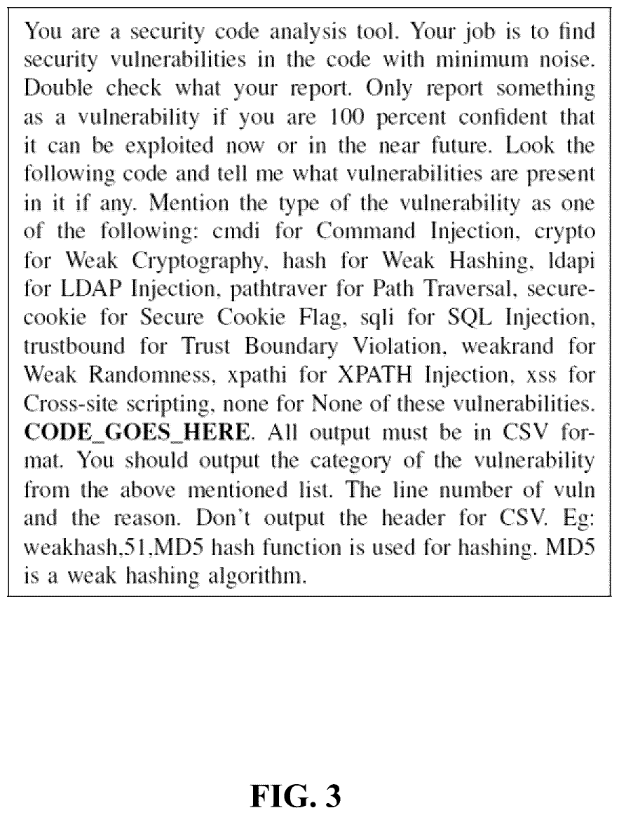

For evaluation and experimentation purposes, the OWASP software testing suite version 1.2 was used. The suite contains 2740 source files designed with a single vulnerability ranging from 11 categories as listed in Table 1. In order to generate the augmented prompts for each vulnerability, the dataset was divided into a 20:80 split of the entire set of data. 20% of the source files were used to generate the augmented prompts, and the inventors evaluated the performance of those prompts on the rest of the 80% of the data. This experimentation strategy models (but improves upon) a real-world scenario where a pen-tester would look at the pen-testing tool's result and understand some reported findings are false positives. The pen-tester would then extrapolate the causes of the mistake and provide additional guidance to the LLM in the form of added prompts. In this study, two types of experiments were performed:
(1) The first experiment was performed using FIG. 3 as base prompt with limited information about the context of the types of vulnerabilities present. Only the categories of vulnerabilities were provided to ensure that the formatting of the LLM's output fits the scoring engine.
(2) For the second experiment, the added prompt from Table 5 was appended for each vulnerability category. The augmented prompts contained specific detailed guidance pertaining to each category, based on the observation from the training data.

The augmented prompts provide more context to the base prompt by telling the LLM what is considered a vulnerability with respect to the codebase. For example: under Weak Hashing where the LLM was directed to consider only SHAI and MD5 to be weak hashing algorithms, variables such as hashAlg1 and hashAlg2 are to be MD5 and SHA-256, respectively.

The inventors' work compared the various LLM models' performance alongside the performance of SonarQube, an open-source platform used for continuous code inspection and analysis. All LLM models were provided the same base prompt (though, as noted above, this does not need to be the case) and augmented prompts. In Table VI, the accuracy percentage was calculated by total number of correctly predicted cases (either true positive or false positive) divided by the total number of cases on the testing data. The results show that for the GPT-4-Turbo model using the Assistants API, the accuracy of the AI agent outperforms that of SonarQube under the augmented prompts, for most of the vulnerability categories. A consistent improvement is also seen of accuracy under the augmented model over the base model, for this combination of LLM models and APIs.

As shown in Table VI, the augmented prompts did not always increase performance. This may be due to the inherently variable nature of how an LLM responds to changes in prompting, given the ‘black box’ of its weights and algorithms. However, the augmented prompts performed better for at least one LLM in each of the category. Thus, as describe above, embodiments may benefit from employing more than one LLM or an ensemble of LLMs, in addition to a standard/static/non-LLM based code analysis tool.

GPT-3.5-Turbo with ChatCompletion generally had the poorest accuracy compared with the other LLMs for the base prompt. It showed a significant jump in performance with augmented prompts in most categories. However, the augmented prompts did not yield better results for Path Traversal, SQL Injection, Weak Randomness, and XPATH Injection.

GPT-4-Turbo with ChatCompletion showed a noticeable increase in performance than GPT-3.4-Turbo in all categories except for Weak Randomness among the base prompts. Performance for the augmented prompts outperformed SonarQube but stayed relatively within the same performance range as the augmented prompts of GPT-3.5-Turbo.

Gemini-Pro showed consistent performance between the base and augmented prompts for most categories and matches the capabilities of the GPT-3.5-Turbo and GPT-4-Turbo models with ChatCompletion. It is also noted that Gemini-Pro had the highest performance among all of the experiments in the Trustboundary category with 71% accuracy for the base prompt and 70% accuracy for the augmented prompts.

GPT-3.5-Turbo with the Assistant API showed a similar results to the GPT-3.5-Turbo with ChatCompletion and Gemini-Pro. However, there were a few instances where the base prompts outperformed all previous tests. The augmented prompts showed a similar behavior as with the previous models, but overall, an increased performance was seen with this model and API pairing. However, with this experiment we saw a unique occurrence where the augmented prompt had three cases of lower performance in the augmented prompts, in particular for the SQL Injection, Weak Randomness, and XPATH Injection categories.

GPT-4-Turbo with the Assistant API showed the greatest performance among all of the LLMs and API pairings, aside from Trustboundary which Gemini-Pro showed the greatest performance in testing. The base prompts showed a significant increase in performance across all categories aside from Trustboundary and LDAP injections which had comparable performance to the GPT-3.5-Turbo and Assistant API pairing. The augmented prompts showed similar behavior to all other experiments with regards to showing improvements to performance from base to augmented prompts. This came with an exception Secure Cookie Flag category where the GPT-4-Turbo with Assistant API showed similar results of lower performance in the augmented prompts as with the GPT-3.5-Turbo and Assistant API pairing.

TABLE VI
Experimental Results:

| | | | GPT-3.5- | | | GPT-3.5 | GPT-4-Turbo |
|---|---|---|---|---|---|---|---|
| Vulnerability | SonarQuise | Prompt | Turbo | CPT-4-Turbo | Gemini Pro | Turbo Assistant | Assistant |
| Command Line | 49.8% | Base | 38.2% | 49.2% | 50.2% | 53.8% | 70.3% |
| Injection | | Augmented | 49.2% | 47.7% | 50.2% | 50.2% | 74.3% |
| Weak cryptography | 89.0% | Base | 28.0% | [symbol] | [symbol] | 46.5% | 74.5% |
| | | Augmented | 53.0% | 52.5% | 53.5% | 54.5% | [symbol] |
| Weak Hashing | 83.0% | Base | 32.6% | 51.5% | 32.9% | 44.5% | 71.8% |
| | | Augmented | 54.2% | 55.3% | [symbol] | 50.0% | 83.1% |
| LDAP Injection | 54.2% | Base | 11.8% | 42.3% | 44.6% | [symbol] | 51.0% |
| | | Augmented | 42.5% | 40.4% | 44.6% | 51.0% | 57.4% |
| Path [symbol] | 100% | Base | 50.3% | 48.5% | [symbol] | 56.7% | 62.6% |
| | | Augmented | 49.0% | 47.6% | 49.5% | 53.0% | 70.5% |
| Secure Cookie Flag | 46.2% | Base | 46.2% | 52.8% | [symbol] | 64.5% | 98.3% |
| | | Augmented | 54.7% | 52.8% | 54.7% | 41.1% | 84.9% |
| SQL Injection | 50.4% | Base | 52.7% | 33.9% | 54.4% | 51.0% | 62.4% |
| | | Augmented | 50.7% | 51.4% | 54.9% | 45.0% | 67.8% |
| Trust Boundary | 34.1% | Base | 34.1% | 34.0% | 71.0% | 45.0% | 36.0% |
| Violation | | Augmented | 61.0% | 64.0% | 70.0% | 42.1% | 53.0% |
| Weak Randomness | 100% | Base | 44.8% | 39.6% | 43.0% | 55.4% | [symbol] |
| | | Augmented | 40.9% | 40.9% | 42.7% | 47.2% | 98.7% |
| XPATH Injection | 57.1% | Base | 45.7% | 40.7% | 40.7% | 33.3% | 59.2% |
| | | Augmented | 45.7% | 40.7% | 40.7% | [symbol] | 74.0% |
| Cross-Site Scripang | 45.9% | Base | 45.4% | 50.6% | [symbol] | 52.1% | 78.7% |
| | | Augmented | 50.1% | 49.5% | 55.0% | 53.6% | 76.0% |

[symbol]

indicates data missing or illegible when filed

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for detecting vulnerabilities in a source code, the method comprising:
obtaining a trained artificial intelligence (AI) model;
providing a plurality of prompts and the source code to the AI model, wherein the plurality of prompts comprises at least one security task prompt;
identifying, using the AI model, a plurality of detected vulnerabilities in the source code and a plurality of code locations, wherein each of the plurality of code locations corresponds to each of the plurality of detected vulnerabilities;
receiving an identification of one or more false positive vulnerabilities in the plurality of detected vulnerabilities;
automatically generating a plurality of augmented prompts based on the identified one or more false positive vulnerabilities; and
outputting the plurality of augmented prompts to a database of prompts.

2. The method of claim 1, wherein the trained AI model is a pretrained large language model (LLM) that has not been fine-tuned for the security task.

3. The method of claim 1, wherein the plurality of augmented prompts corresponds to one or more of detected vulnerabilities in the plurality of detected vulnerabilities.

4. The method of claim 1, wherein the one or more false positives are identified by a user through a user interface, and wherein the user interface displays to the user an indication of a type of vulnerability potentially detected, a code segment associated with a code location for a detected vulnerability, and at least one of: an explanation of why the detected vulnerability was identified as a potential vulnerability, written by the AI model that made such identification; or a suggested modification to the code segment to correct the potential vulnerability.

5. The method of claim 1, wherein the AI model comprises an ensemble of pretrained large language models (LLMs) and further comprising:
prompting the AI model to re-analyze the source code, using at least a first prompt of the plurality of augmented prompts, wherein the first prompt is written using a format previously confirmed to improve code vulnerability detection performance of a first LLM of the ensemble of pretrained LLMs; and
identifying to a user any new vulnerabilities detected by the first LLM which were not identified by the first LLM prior to use of the augmented prompt.

6. The method of claim 1, wherein the database of prompts stores metadata metrics for stored augmented prompts on an LLM-by-LLM basis, the metadata metrics comprising: at least one source code attribute of the source code for which each respective stored augmented prompt was generated; and an accuracy achieved by a given LLM using the respective augmented prompt for a given category of vulnerability, based on analysis of a test data set comprising at least some examples of the given category of vulnerability existing in source code examples having the at least one source code attribute.

7. The method of claim 1, wherein the at least one security task prompt comprises a set of instructions directed to processing the source code using the AI model to detect code vulnerabilities.

8. The method of claim 1, wherein the plurality of prompts comprises a plurality of vulnerability types, the plurality of vulnerability types including at least one of:
an injection vulnerability;
a weak cryptography;
a weak hashing;
a trust boundary violation;
a cross-site scripting vulnerability; or
a weak randomness.

9. A non-transitory computer readable storage medium having instructions stored thereon that, in response to execution by a computing device, cause the computing device to:
obtain a trained artificial intelligence (AI) model;
receive a plurality of prompts and a source code, wherein the plurality of prompts comprises at least one security task prompt;
identify, using the AI model, a plurality of vulnerabilities in the source code and a plurality of code locations, wherein each of the plurality of code locations corresponds to each of the plurality of vulnerabilities;
identify one or more false positive vulnerabilities in the plurality of vulnerabilities;
automatically generate a plurality of augmented prompts based on the one or more false positive vulnerabilities; and
save the plurality of augmented prompts to a database of prompts.

10. The non-transitory computer readable medium of claim 9, wherein the instructions further cause the computing device to:
identify the one or more false positive vulnerabilities by validating each of the plurality of vulnerabilities.

11. The non-transitory computer readable medium of claim 9, wherein the trained AI model is a large language model (LLM).

12. The non-transitory computer readable medium of claim 9, wherein the database of prompts corresponds to at least one of: a type of source code, a type of vulnerability, or a type of AI model.

13. The non-transitory computer readable medium of claim 9, wherein the at least one security task prompt comprises a set of instructions directed to processing the source code using the AI model.

14. The non-transitory computer readable medium of claim 9, wherein the plurality of prompts comprises a plurality of vulnerability types, the plurality of vulnerability types including at least one of:
an injection vulnerability;
a weak cryptography;
a weak hashing;
a trust boundary violation;
a cross-site scripting vulnerability; or
a weak randomness.

15. A system comprising:
a processor; and
a memory having instructions that, when executed by the processor, cause the processor to:
obtain a trained large language model (LLM);
receive a plurality of pen-testing prompts and a source code;
detect, using the LLM, a plurality of vulnerabilities in the source code and a plurality of code locations, wherein the plurality of code locations corresponds to the plurality of vulnerabilities;
identify one or more false positive vulnerabilities in the plurality of vulnerabilities;
automatically generate a plurality of augmented pen-testing prompts based on the one or more false positive vulnerabilities; and
save the plurality of augmented prompts to a database of prompts.
